(19) United States
(12) Patent Application Publication
(10) Pub. No.: US 2010/0105352 A1
(43) Pub. Date: Apr. 29, 2010

(54) MOBILE COMMUNICATION SYSTEM, MANAGEMENT SERVER DEVICE, BASE STATION DEVICE, AND LINE RESERVATION METHOD

(75) Inventor: Goro Ikeda, Yokohama-shi (JP)

Correspondence Address: MORRISON & FOERSTER LLP, 12531 HIGH BLUFF DRIVE, SUITE 100, SAN DIEGO, CA, 92130-2040, US

(73) Assignee: Kyocera Corporation, Kyoto (JP)

(21) Appl. No.: 12/529,014

(22) PCT Filed: Feb. 21, 2008
(86) PCT No.: PCT/JP2008/052974

§ 371 Date: Aug. 27, 2009

(30) Foreign Application Priority Data
Feb. 27, 2007 (JP) 2007 046377

(51) Int. Cl. H04M 11/04

(52) U.S. Cl. 455/404.2

(57) ABSTRACT

A base station (12A-1) notifies a management server (16) of termination of an emergency call. The management server (16) specifies the location registration area of the mobile terminal with the emergency call terminated, based on the notice, and instructs base stations (12A-1) and (12A-2) belonging to the specified location registration area to hold a line to be allocated to a callback for the emergency call. Each of the base stations (12A-1) and (12A-2) holds a line to be allocated to a callback for the emergency call, based on the line hold instruction.

### TECHNICAL FIELD

The present invention relates to a mobile communication system, a management server device, a base station device, and a line hold method, and in particular to a technique related to a callback to be made after termination of an emergency call for reporting crimes, accidents, fire, emergency, and so forth.

### BACKGROUND ART

As one of the telephone services, there is available an emergency call for reporting crimes, accidents, fire, emergency, and so forth. In a mobile communication system, such as PHS (Personal Handyphone System), in order to ensure, when an emergency call from a mobile terminal is terminated, a successful callback from the called party (the police, coast guard, fire station, and so forth) of the emergency call, a line to be allocated to the callback is kept held for a predetermined period of time in a base station.

For example, Patent Document 1 mentioned below discloses a callback process method for reserving, when an emergency call made in mobile communication is terminated, a predetermined channel between a base station and a mobile switching center for reporting emergency to thereby ensure that the called party of the emergency call can correctly make a callback to the calling party.
Patent Document 1: JP 7-254933 A

### DISCLOSURE OF THE INVENTION

### Problems To Be Solved By the Invention

According to the above described conventional mobile communication system, however, a line held after termination of an emergency call is limited to the line between the base station to which the calling mobile terminal is connected and the switching center. Therefore, should the mobile terminal have moved to an area under control of a base station different from that base station by the time when the called party of the emergency call makes a callback to the mobile terminal, there may be a case in which the callback is failed to be made as a line for a callback for the emergency call is not always available in the base station to which the mobile terminal has moved.

The present invention has been conceived in view of the above described problem, and an object thereof is to provide a mobile communication system, a management server device, a base station device, and a line hold method for ensuring a successful callback for an emergency call.

### Means For Solving the Problems

In order to achieve the above described object, a mobile communication system according to the present invention is a mobile communication system having a plurality of base station devices and a management server device for managing, based on a location registration request from a mobile terminal, a location registration area where the mobile terminal is located, wherein each of the base station devices includes emergency call termination notifying means for notifying the management server device of termination of an emergency call, the management server device includes terminal location specifying means for specifying a location registration area where a mobile terminal with the emergency call terminated is located, based on a notice sent by the emergency call termination notifying means, and line hold control means for instructing a base station device belonging to the location registration area specified by the terminal location specifying means to hold a line to be allocated to a callback for the emergency call, and each of the base station devices further includes line hold means for reserving a line to be allocated to a callback for the emergency call, based on a line hold instruction made by the line hold control means.

According to the present invention, once an emergency call from a mobile terminal is terminated, the current location registration area (referred to also as a paging area) of the mobile terminal with the emergency call terminated is specified, and all of the base station devices belonging to the specified location registration area are instructed to hold a line as preparation for a callback for the emergency call. With the above, it is ensured, after termination of an emergency call, that a callback for the emergency call can be successfully made wherever the calling mobile terminal has moved.

In one aspect of the present invention, each of the base station devices may further include terminal in-zone determination means for determining whether or not the mobile terminal with the emergency call terminated is located in its own radio zone, based on the line hold instruction made by the line hold control means, and the line hold means may hold a line to be allocated to a callback for the emergency call when the terminal in-zone determination means determines that the mobile terminal with the emergency call terminated is located in its own radio zone. According to this aspect, as only a base station device which can call up the mobile terminal with the emergency call terminated holds a line, reduction of line resources available in the same location registration area can be minimized.

In one aspect of the present invention, in response to a location registration request from the mobile terminal with the emergency call terminated, the line hold control means may instruct a base station device belonging to a new location registration area where the mobile terminal is located to hold a line to be allocated to a callback for the emergency call. According to this aspect, even though the calling mobile terminal has moved after termination of the emergency call to a different location registration area from that location registration area where the mobile terminal is located when the termination occurs, it is ensured that a callback for the emergency call is successfully made.

In this aspect, the line hold control means may further instruct a base station device having held a line to be allocated to a callback for the emergency call since before the location registration request is made, to release the line held. With the above, should the mobile terminal having made the emergency call have moved to a different location registration area, the line held in the location registration area from which the mobile terminal has moved is automatically released. This can prevent reduction of the line resources available.

In one aspect of the present invention, the line hold control means may instruct, after elapse of a predetermined period of time after the emergency call termination notifying means sends the notice, a base station device which is reserving a line to be allocated to a callback for the emergency call to release the line held. According to this aspect, as a period for reserving a line for a callback for the emergency call is limited to a predetermined period of time, reduction of the line resources available can be prevented.

A management server device according to the present invention is a management server device communicably connected to a plurality of respective base station devices, for managing, based on a location registration request from a mobile terminal, a location registration area where the mobile terminal is located, the device including terminal location specifying means for specifying, based on a termination notice of an emergency call, sent from each of the base station devices, a location registration area where a mobile terminal with the emergency call terminated is located; and line hold control means for instructing a base station device belonging to the location registration area specified by the terminal location specifying means to hold a line to be allocated to a callback for the emergency call.

A base station device according to the present invention is abase station device communicably connected to a management server device for managing, based on a location registration request from a mobile terminal, a location registration area where the mobile terminal is located, the device including emergency call termination notifying means for notifying the management server device of termination of an emergency call; and line hold means for reserving a line to be allocated to a callback for the emergency call, based on a line hold instruction from the management server device.

A line hold method according to the present invention is a line hold method for reserving, when an emergency call from a mobile terminal is terminated, a line to be allocated to a callback for the emergency call, the method including a terminal location specifying step of specifying a location registration area where a mobile terminal with the emergency call terminated is located; and a line hold instruction step of instructing abase station device belonging to the location registration area specified at the terminal location specifying step to hold a line to be allocated to a callback for the emergency call.

### BRIEF DESCRIPTION OF THE DRAWINGS

FIG. 1 is an entire configuration diagram of a mobile communication system according to an embodiment of the present invention;

FIG. 2 is a block diagram of a base station according to the embodiment of the present invention;

FIG. 3 is a block diagram of a management server according to the embodiment of the present invention;

FIG. 4 is a diagram showing a line hold process sequence to be carried out immediately after abnormal termination of an emergency call;

FIG. 5 is a diagram showing a line hold process sequence to be carried out when a mobile terminal has moved to a different radio zone within the same location registration area; and

FIG. 6 is a diagram showing a line hold process sequence to be carried out when a mobile terminal has moved to a different location registration area.

### BEST MODE FOR CARRYING OUT THE INVENTION

In the following, an embodiment of the present invention will be described, based on the accompanying drawings.

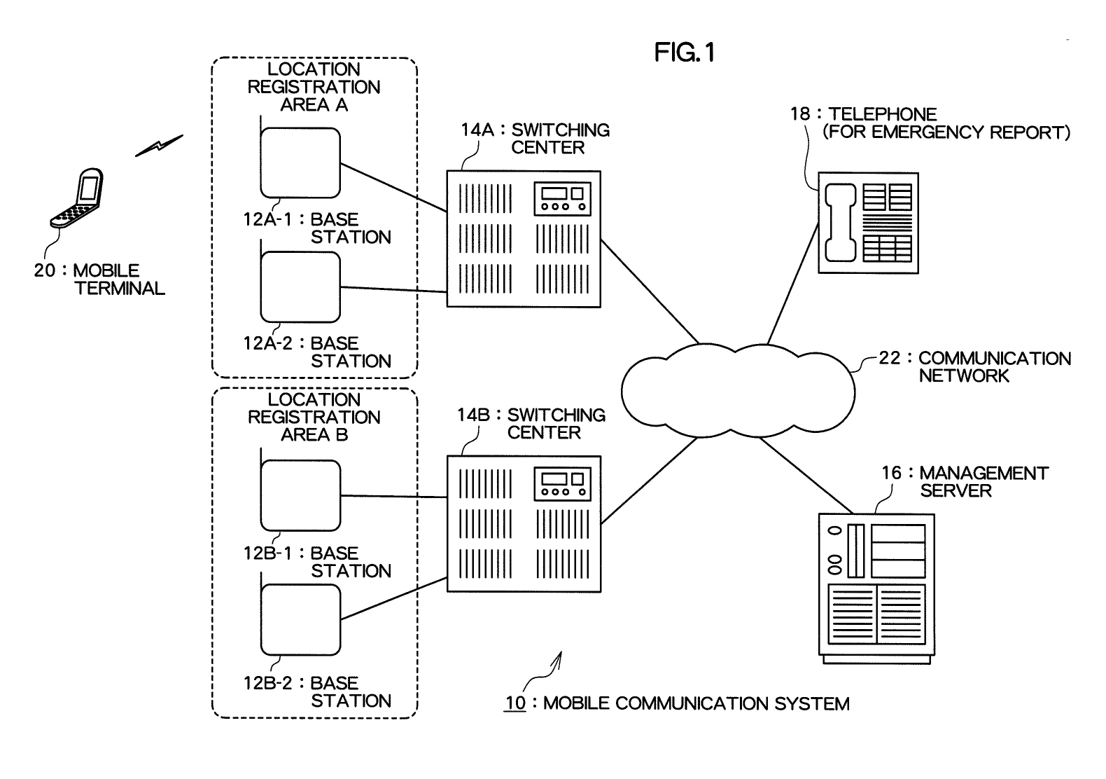

FIG. 1 is an entire configuration diagram of a mobile communication system 10 according to an embodiment of the present invention. As shown in the diagram, the mobile communication system 10 includes a plurality of base stations 12 (four here, namely 12A-1, 12A-2, 12B-1, and 12B-2), a plurality of switching centers 14 (two here, namely 14A and 14B), and a management server 16.

The base station 12 has an antenna and sends and receives a radio signal to and from a mobile terminal 20 located in its own radio zone (cell). The base station 12 also sends and receives a message to and from another base station 12 or the management server 16 through an switching center 14 connected via a wired transmission path (e.g., ISDN: Integrated Service Digital Network) and a communication network 22.

The management server 16 is a publicly known server computer including a program execution means, such as a CPU, or the like, and a storage means, such as a RAM, a ROM, a hard disk storage device, or the like, and manages for every mobile terminal 20 a “location registration area”, or a minimal unit for specifying the location of a mobile terminal 20. The location registration area includes radio zones of one or more base stations 12, and is referred to as a “paging area” as, upon receipt of a call to a mobile terminal 20, all of the base stations 12 belonging to the location registration area where the mobile terminal 20 is located simultaneously call up (an incoming call notice) the mobile terminal 20.

A mobile terminal 20 regularly receives a location registration area number from a base station 12 located close thereto, and every receipt of a different location registration area number, sends the management server 16 a location registration request including the received location registration area number and its own telephone number, so that the management server 16 updates the location registration area of the mobile terminal 20, based on the location registration request received from the mobile terminal 20. The series of processes are referred to as “location registration”, and make it possible to track in units of a location registration area the location of a mobile terminal 20, which is changing as time passes.

In this mobile communication system 10, when an emergency call from a mobile terminal 20 to a telephone 18 (for emergency report) is terminated abnormally, the fact of abnormal termination is notified to the management server 16 by the base station 12 having wirelessly communicated with that mobile terminal 20. Based on the notice, the management server 16 specifies the location registration area of the mobile terminal 20 with the emergency call terminated, and instructs all of the base stations 23 belonging to the specified location registration area to hold a line as preparation for a callback from the telephone 18 for the emergency call. Should the mobile terminal 20 have thereafter moved to a different location registration area, the management server 16 specifies the new location registration area to which the mobile terminal 20 currently belongs, based on the location registration carried out accompanying the movement, and again similarly instructs all of the base stations 12 belonging to the new location registration area to hold a line. As described above, according to the mobile communication system 10, it is ensured that a callback for an emergency call can be successfully made by the telephone 18 wherever the mobile terminal 20 having made an emergency call has moved after termination of the emergency call.

In the following, a configuration of the base station 12 and the management server 16 for realizing the above described process will be described in detail.

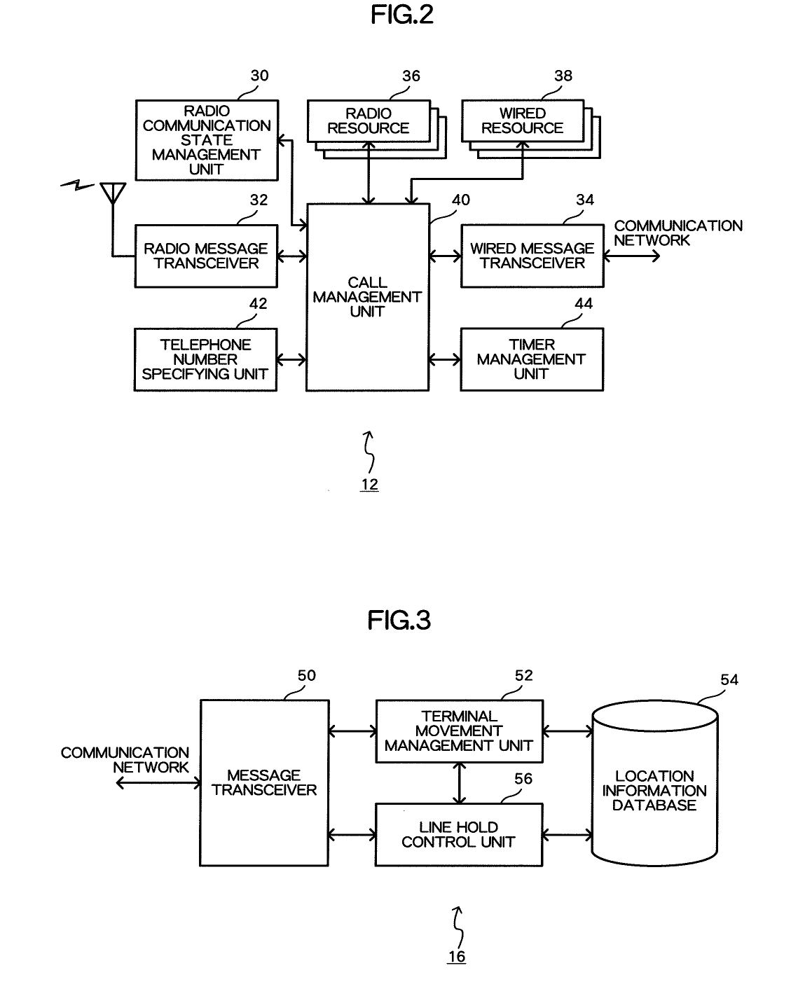

FIG. 2 is a block diagram of the base station 12. As shown in the diagram, the base station 12 includes a radio communication state management unit 30, a radio message transceiver 32, a wired message transceiver 34, a radio resource 36, a wired resource 38, a call management unit 40, a telephone number specifying unit 42, and a timer management unit 44.

The radio communication state management unit 30 always monitors the state of radio communication with a mobile terminal 20 from the beginning to the end of connection, and notifies the call management unit 40 of any change, if any, in the communication state. For example, with radio communication terminated, the radio communication state management unit 30 instantly notifies the call management unit 40 of the fact of termination.

The radio message transceiver 32, which has an antenna, converts a radio signal received via the antenna into a radio received message, and outputs to the call management unit 40. Further, the radio message transceiver 32 converts a radio transmitting message input from the call management unit 40 into a radio signal, and transmits via the antenna. For example, the radio message transceiver 32 sends an incoming call notice for calling up a mobile terminal 20 and a call end notice for notifying the end of communication through a radio control channel, regularly sends a location registration area number indicating the location registration area to which its own base station 12 belongs, and receives an incoming call response, or the like, from a mobile terminal 20.

The wired message transceiver 34, connected to the communication network 22 via the switching center 14 connected via a wired transmission path, converts a signal received from the communication network 22 into a wired received message, and outputs to the call management unit 40. Further, the wired message transceiver 34 converts a wired transmitting message input from the call management unit 40 into a transmitting signal, and sends to the communication network 22. For example, the wired message transceiver 34 receives a line hold start instruction and a line hold release instruction from the management server 16 and an incoming call notice and a call end notice from the switching center 14, and sends an emergency call termination notice and a line hold start notice to the management server 16.

The call management unit 40 manages a series of processes from connection to termination (including a hold state) of radio communication and wired communication. Specifically, the call management unit 40 controls allocation of a line, depending on the state of use of the radio resource 36 used for radio communication with a mobile terminal 20 and the wired resource 38 used for wired communication with the switching center 14. For example, upon receipt of an incoming call response from the mobile terminal 20 after sending an incoming call notice, the call management unit 40 stores the identification number (e.g., the telephone number) of the mobile terminal 20 and the identification numbers of both of the above described line resources so as to be correlated to each other in order to allocate a line to the call. In the above, if neither of the radio resource 36 nor the wired resource 38 is available, line allocation is not successfully done, and therefore communication connection is not established. Meanwhile, upon receipt of a call end notice from the communication network 22, the call management unit 40 releases the correlation between the identification number of the mobile terminal 20 and those of both of the above described resources to thereby release the line allocated to the call.

Meanwhile, upon receipt of a notice from the radio communication state management unit 30 to the effect that radio communication is terminated abnormally, the call management unit notifies the telephone number specifying unit 42 of a communication identification number identifying the terminated communication, and obtains from the telephone number specifying unit 42 the telephone numbers of the calling and called parties of the communication. In the case where the communication is an emergency call made from a mobile terminal 20 (e.g., when the called telephone number is “110”, “118”, “119”, or the like), the call management unit 40 sends an emergency call termination notice containing the telephone number of the calling party to the management server 16.

Further, upon receipt of a line hold start instruction from the management server 16, the call management unit 40 sends an incoming call notice containing the telephone number contained in the line hold start instruction to its own radio zone, and determines whether or not a mobile terminal 20 corresponding to the telephone number is located in its own radio area, based on whether or not an incoming call response is returned. Only when it is determined that the mobile terminal 20 is located in the area, the call management unit 40 stores the telephone number contained in the line hold start instruction as a callback awaiting number of the emergency call, then holds one line to be allocated to a callback for the emergency call, and reduces by one the respective numbers of the available radio resources 36 and wired resources 38. Further, simultaneously with reserving a line, the call management unit 40 sends a line hold start notice containing the telephone number contained in the line hold start instruction to the management server 16, and instructs the timer management unit 44 to be described later to start counting on a timer. Thereafter, every receipt of a notice from the timer management unit 44 about occurrence of a timer event at a constant cycle, the call management unit 40 determines whether or not the mobile terminal 20 remains in its own radio zone to thereby determine whether or not to preserve the line held. That is, the call management unit 40 determines to preserve the line held when presence of the mobile terminal 20 in its own radio zone is determined, and determines to release the line held when the presence is not determined, based on the determination that the mobile terminal 20 has moved out of it own radio zone. In the latter case, the call management unit 40 sends a terminal movement notice containing the telephone number of the mobile terminal 20 to the management server 16. Note that the call management unit 40 releases the held line also upon receipt of a line hold release instruction from the management server 16.

The telephone number specifying unit 42 specifies the calling number and the called number of the communication identified by the communication identification number, based on the communication identification number notified by the call management unit 40, and notifies the call management unit 40 of the specified telephone numbers.

The timer management unit 44 starts or suspends counting on the timer according to an instruction from the call management unit 40, and notifies the call management unit 40 of a timer event occurring at a constant cycle during a period from the start to the end of the counting.

FIG. 3 is a block diagram of the management server 16. As shown in the diagram, the management server 16 includes a message transceiver 50, a terminal movement management unit 52, a location information database 54, and a line hold control unit 56.

The message transceiver 50, connected via a wired transmission path to the communication network 22, converts a signal received from the communication network 22 into a received message, and outputs to the terminal movement management unit 52 or the line hold control unit 56. Further, the message transceiver 50 converts a transmitting message input from the terminal movement management unit 52 or the line hold control unit 56 into a transmitting signal, and sends to the communication network 22. For example, the message transceiver 50 receives a location registration request from the mobile terminal 20, an emergency call termination notice, a line hold start notice, and so forth, from the base station 12, and sends a line hold start instruction and a line hold release instruction to the base station 12.

The terminal movement management unit 52 manages for every mobile terminal 20 a location registration area for specifying the location of the mobile terminal 20. That is, based on a location registration request from a mobile terminal 20, the terminal movement management unit 52 registers the telephone number and the location registration area number both contained in the location registration request in the location information database 54 so as to be correlated to each other. Further, in response to a terminal location obtaining request from the switching center 14, the terminal movement management unit 52 reads from the location information database 54 a location information area number correlated to the telephone number contained in the request, and sends to the switching center 14.

Still further, in response to the location registration request, the terminal movement management unit 52 sends a location registration notice containing the telephone number contained in the request to the line hold control unit 56 to be described later. With the notice, the line hold control unit 56 realizes the fact that a new location registration request has been sent from the mobile terminal 20 (that is, the mobile terminal 20 has moved to a new location registration area).

The location information database 54 includes, for example, a hard disk storage device, and stores the telephone number of a mobile terminal 20 and the number of the location registration area where the mobile terminal 20 is located so as to be correlated to each other. Further, the location information database 54 stores the base station identification number of a base station 12 belonging to the location registration area identified by the location registration area number, in correlation to the location registration area number.

The line hold control unit 56 controls hold of a line in the mobile communication system 10, and in particular, when an emergency call made from a mobile terminal 20 is terminated abnormally, holds a line resource to ensure a successful callback for the emergency call.

That is, upon receipt of an emergency call termination notice from a base station 12, the line hold control unit 56 stores the telephone number contained in the notice as a callback awaiting number of the emergency call, and obtains the location registration area number from the location registration database 54, based on the telephone number. Then, the line hold control unit 56 obtains one or more base station identification numbers from the location registration database 54, based on the obtained location registration area number, then sends a line hold instruction containing the telephone number to the base stations 12 identified by the obtained base station identification numbers. In this manner, the line hold control unit 56 instructs one or more base stations 12 belonging to the location registration area where the mobile terminal 20 with the emergency call terminated is located to hold a line to be allocated to a callback for the emergency call.

Note that, simultaneously with instructing to hold a line, the line hold control unit 56 starts counting on a hold timer. When no line hold start notice containing the telephone number contained in the instruction is returned from any base station 12 within a predetermined period of time after sending the line hold instruction, the line hold control unit 56 determines failure of line hold, and sends again a line hold instruction to the same base stations 12. Further, even though a line hold start notice is returned from any base station 12, the line hold control unit 56 sends again a line hold instruction when a terminal movement notice is thereafter received from the same base station 12 (that is, a notice telling that the line held is released as the mobile terminal 20 with the emergency call terminated has moved out of its own radio zone) to have another base station 12 belonging to the same location registration area to hold a line.

Further, upon receipt of a location registration notice from the terminal movement management unit 52, the line hold control unit 56 determines whether or not the telephone number contained in the notice is the same as the callback awaiting number of the emergency call stored. When the telephone number is the same as the callback awaiting number of the emergency call, the line hold control unit 56 determines that the mobile terminal 20 with the emergency call terminated has moved to a new location registration area, and sends a line hold notice to the base station 12 belonging to the location registration area. That is, the line hold control unit 56 specifies a new location registration area where the mobile terminal 20 with the emergency call terminated is currently located, based on the telephone number notified by the terminal movement management unit 52, and instructs one or more base stations 12 belonging to the specified location registration area to hold a line to be allocated to a callback for the emergency call.

With the above, when an emergency call from a mobile terminal 20 is terminated abnormally, the line hold control unit 56 ensures that a callback for the emergency call can be successfully made to whichever radio zone in whichever location registration area the calling mobile terminal 20 has moved. Note that when the hold timer having started counting in response to an initial line hold instruction reaches the line hold upper limit time defined in the system, the line hold control unit 56 sends a line hold release notice to the base station 12 which is reserving a line, and also deletes the telephone number stored as the callback awaiting number of the emergency call to thereby end the control for line hold related to a callback for the emergency call.

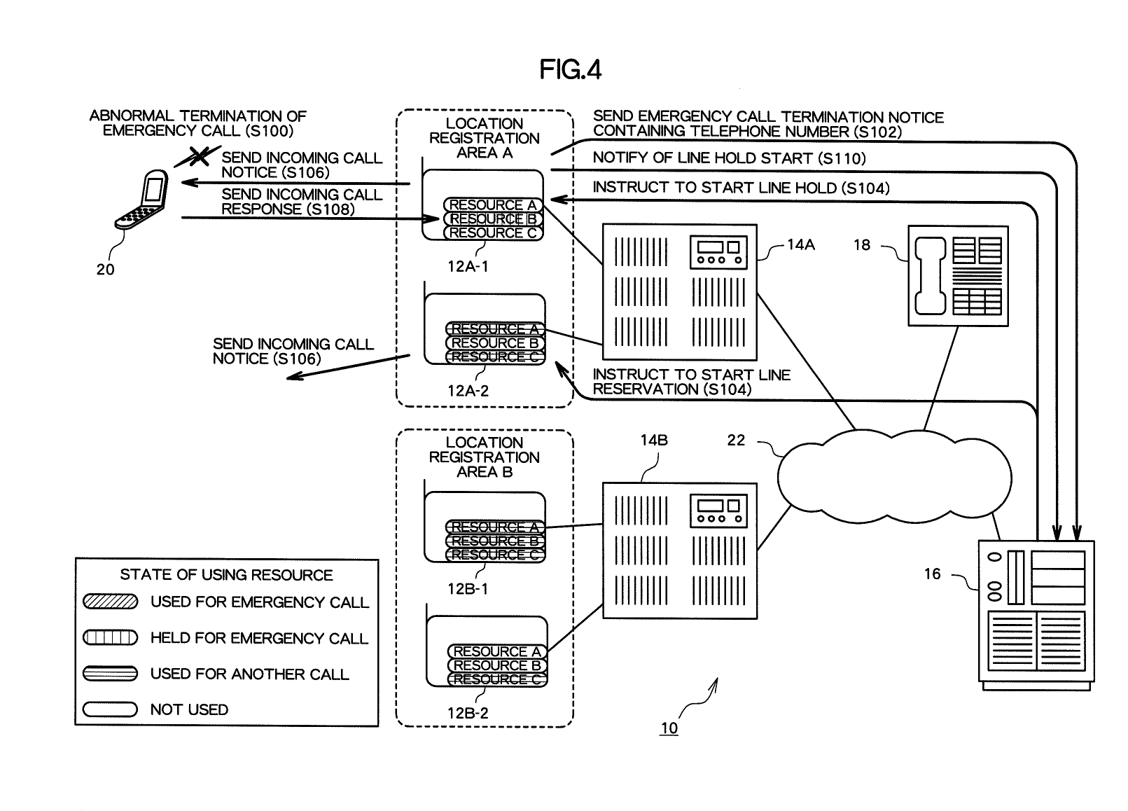

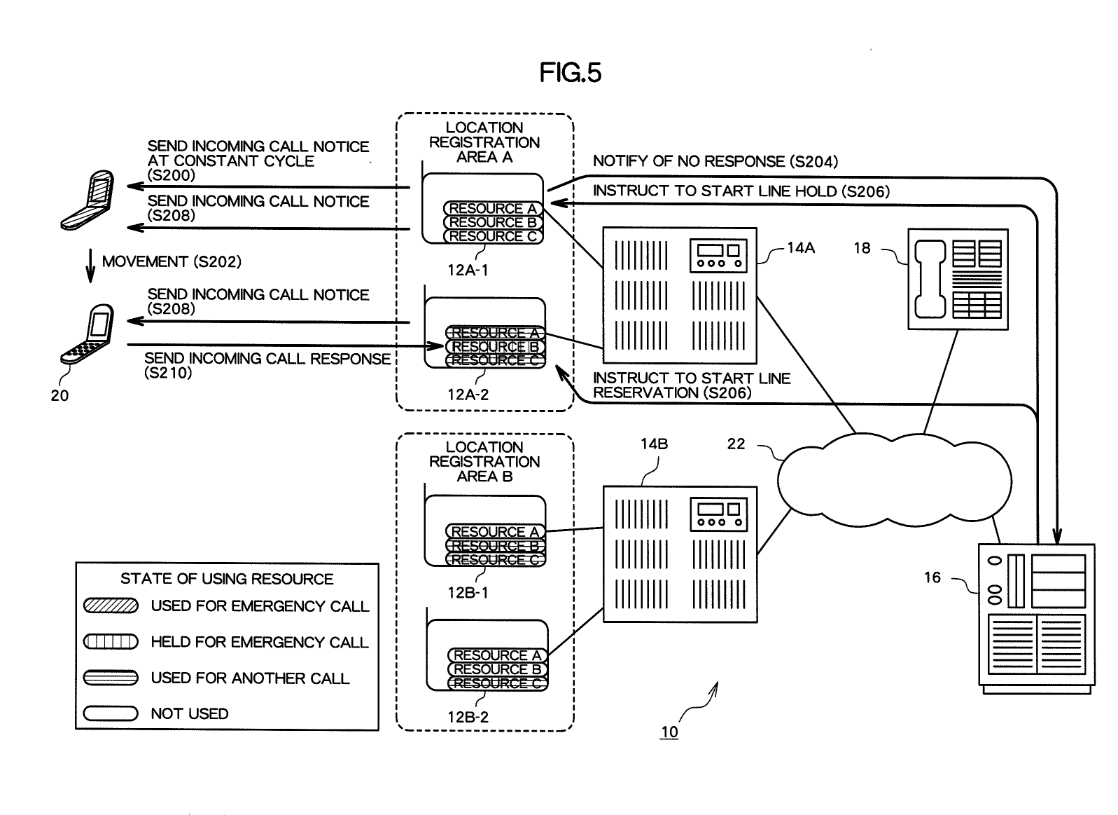

Here, a series of line hold processes to be carried out in the mobile communication system 10 when an emergency call is terminated abnormally will be described based on FIGS. 4 to 6. Note that in FIGS. 4 to 6, assume that the base stations 12A-1 and 12A-2 connected to the switching center 14A belong to the location registration area A, and that the base stations 12B-1 and 12B-2 connected to the switching center 14B belong to the location registration area B.

FIG. 4 is a diagram showing a line hold process sequence to be carried out immediately after abnormal termination of an emergency call from a mobile terminal 20. As shown in the diagram, when radio communication between the mobile communication 20 and the base station 12A-1 is terminated abnormally while an emergency call is held between the mobile terminal 20 and the telephone 18 for emergency report (S100), the base station 12A-1 sends an emergency call termination notice containing the telephone number of the mobile terminal 20 to the management server 16 (S102). Based on the emergency call termination notice, the management server 16 determines that the mobile communication 20 is located in the location registration area A, and sends a line hold start instruction to the base stations 12A-1 and 12A-2 belonging to the location registration area A (S104).

Having received the line hold start instruction from the management server 16, the base stations 12A-1 and 12A-2 send an incoming call notice containing the telephone number of the mobile terminal 20 to the respective radio zones, based on the instruction (S106). In the above, the mobile terminal 20, which is located in the radio zone of the base station 12A-1, receives the incoming call notice from the base station 12A-1, and returns an incoming call response (S108). The base station 12A-1, having received the incoming call response from the mobile terminal 20, holds a line resource available for allocation (resource B, here), based on the state of use of the line resources (radio resource and wired resource), and notifies the management server 16 of the fact that line hold has been started (S110).

FIG. 5 is a diagram showing a line hold process sequence to be carried out after the process at S110 shown in FIG. 4 when the mobile terminal 20 has moved to a different radio zone in the same location registration area (location registration area A). As shown in the diagram, the base station 12A-1, having started line hold, sends an incoming call notice containing the telephone number of the mobile terminal 20 at a constant cycle to determine whether or not the mobile terminal 20 remains in its own radio zone (S200). Suppose here that the mobile terminal 20 has moved to an adjacent radio zone (a radio zone of the base station 12A-2) (S202). Then, the base station 12A-1 can no longer receive an incoming call response from the mobile terminal 20 although having sent an incoming call notice. In this case, the base station 12A-1 releases hold of the line resource B, and notifies the management server 16 of the fact that no incoming call response is received from the mobile terminal 20 (that is, the fact that the mobile terminal 20 has moved out of its own radio zone) (S204). Upon receipt of the notice from the base station 12A-1 telling that no incoming call response is received, the management server 16 sends again a line hold start instruction to the base stations 12A-1 and 12A-2 belonging to the location registration area A (S206).

The base stations 12A-1 and 12A-2, having received the line hold start instruction from the management server 16, send an incoming call notice containing the telephone number of the mobile terminal 20 to the respective radio zones, based on the instruction (S208). In the above, the mobile terminal 20, which is then located in the radio zone of the base station 12A-2, receives the incoming call notice from the base station 12A-2, and sends an incoming call response (S210). The base station 12A-2, having received the incoming call response from the mobile terminal 20, holds a line resource available for allocation (resource B, here), based on the state of use of the line resource. In this manner, even though the mobile terminal 20 has moved to a different radio zone in the same location registration area after an emergency call made thereby is terminated abnormally, it is ensured that a callback for the emergency call can be successfully made.

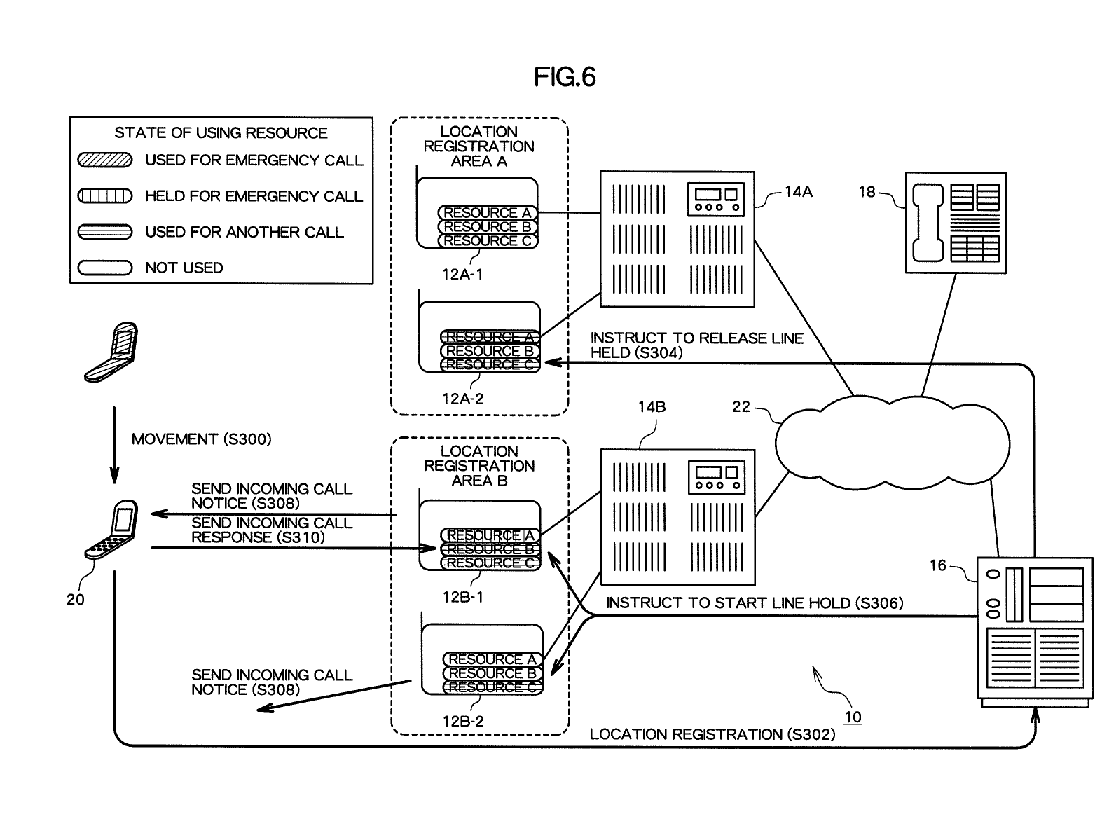

FIG. 6 is a diagram showing a line hold process sequence to be carried out after the process at S210 shown in FIG. 5 when the mobile terminal 20 has moved to a different location registration area (location registration area B). As shown in the diagram, when the mobile terminal 20 has moved from the location registration area A to the location registration area B (S300), the mobile terminal 20 carries out location registration relative to the management server 16 (S302). Based on the location registration request from the mobile terminal 20, the management server 16 realizes that the mobile terminal 20 has moved to the location registration area B, and then sends a line hold release instruction to the base station 12A-2, which no longer needs a line held (S304). The base station 12A-2, having received the line hold release instruction from the management server 16, releases the line resource held (resource B), based on the instruction. Simultaneously, the management server 16 sends a line hold start instruction to the base stations 12B-1 and 12B-2 belonging to the location registration area B to which the mobile terminal 20 has moved (S306).

The base stations 12B-1 and 12B-2, having received the line hold start instruction from the management server 16, send an incoming call notice containing the telephone number of the mobile terminal 20 to the respective radio zones, based on the instruction (S308). In the above, the mobile terminal 20, which is then located in the radio zone of the base station 12B-1, receives the incoming call notice from the base station 12B-1, and sends an incoming call response (S310). The base station 12B-1, having received the incoming call response from the mobile terminal 20, holds a line resource available for allocation (resource A, here), based on the state of use of the line resource. In this manner, even though the mobile terminal 20 has moved to a different location registration area after an emergency call is terminated abnormally, it is ensured that a callback for the emergency call can be successfully made.

According to the above described embodiment, when an emergency call from a mobile terminal 20 to the telephone 18 for emergency report is abnormally terminated, a base station 12 to hold a line to be allocated to a callback for the emergency call is sequentially changed according to the movement of the calling mobile terminal 20. This can ensure a successful callback from the telephone 18 for the emergency call wherever the mobile terminal 20 has moved.

Note that the present invention is not limited to the above described embodiment, and various modified embodiments can be employed. For example, although an example in which the management server 16 has functions for managing a location registration area and for controlling line hold is described in the above, the respective switching centers 14 or a plurality of cooperatively operable switching centers 14 may have these functions.

Further, although it is described in the above embodiment that base stations 12 connected to the same base station 12 may belong to the same location registration area, obviously, base stations 12 connected to the same switching center 14 may belong to different location registration areas or base stations 12 connected to different switching centers 14 may belong to the same location registration area.

1. A mobile communication system having a plurality of base station devices and a management server device for managing, based on a location registration request from a mobile terminal, a location registration area where the mobile terminal is located, wherein
each of the base station devices comprises emergency call termination notifying means for notifying the management server device of termination of an emergency call,
the management server device comprises
terminal location specifying means for specifying a location registration area where a mobile terminal with the emergency call terminated is located, based on a notice sent by the emergency call termination notifying means, and
line hold control means for instructing a base station device belonging to the location registration area specified by the terminal location specifying means to hold a line to be allocated to a callback for the emergency call, and
each of the base station devices further comprises line hold means for reserving a line to be allocated to a callback for the emergency call, based on a line hold instruction made by the line hold control means.

2. The mobile communication system according to claim 1, wherein each of the base station devices further comprises terminal in-zone determination means for determining whether or not the mobile terminal with the emergency call terminated is located in its own radio zone, based on the line hold instruction made by the line hold control means, and
the line hold means holds a line to be allocated to a callback for the emergency call when the terminal in-zone determination means determines that the mobile terminal with the emergency call terminated is located in its own radio zone.

3. The mobile communication system according to claim 1, wherein, in response to a location registration request from the mobile terminal with the emergency call terminated, the line hold control means instructs a base station device belonging to a new location registration area where the mobile terminal is located to hold a line to be allocated to a callback for the emergency call.

4. The mobile communication system according to claim 3, wherein the line hold control means further instructs a base station device having held a line to be allocated to a callback for the emergency call since before the location registration request is made to release the line held.

5. The mobile communication system according to claim 1, wherein the line hold control means instructs, after elapse of a predetermined period of time after the emergency call termination notifying means sends the notice, a base station device which is reserving a line to be allocated to a callback for the emergency call to release the line held.

6. A management server device communicably connected to a plurality of respective base station devices, for managing, based on a location registration request from a mobile terminal, a location registration area where the mobile terminal is located, comprising:
terminal location specifying means for specifying, based on a termination notice of an emergency call, sent from each of the base station devices, a location registration area where a mobile terminal with the emergency call terminated is located; and
line hold control means for instructing a base station device belonging to the location registration area specified by the terminal location specifying means to hold a line to be allocated to a callback for the emergency call.

7. A base station device communicably connected to a management server device for managing, based on a location registration request from a mobile terminal, a location registration area where the mobile terminal is located, comprising
emergency call termination notifying means for notifying the management server device of termination of an emergency call; and
line hold means for reserving a line to be allocated to a callback for the emergency call, based on a line hold instruction from the management server device.

8. A line hold method for reserving, when an emergency call from a mobile terminal is terminated, a line to be allocated to a callback for the emergency call, comprising:
a terminal location specifying step of specifying a location registration area where a mobile terminal with the emergency call terminated is located; and
a line hold instruction step of instructing a base station device belonging to the location registration area specified at the terminal location specifying step to hold a line to be allocated to a callback for the emergency call.

9. The mobile communication system according to claim 2, wherein, in response to a location registration request from the mobile terminal with the emergency call terminated, the line hold control means instructs a base station device belonging to a new location registration area where the mobile terminal is located to hold a line to be allocated to a callback for the emergency call.

10. The mobile communication system according to claim 2, wherein the line hold control means instructs, after elapse of a predetermined period of time after the emergency call termination notifying means sends the notice, a base station device which is reserving a line to be allocated to a callback for the emergency call to release the line held.
